(19) United States
(12) Patent Application Publication
(10) Pub. No.: US 2002/0081065 A1
(43) Pub. Date: Jun. 27, 2002

(54) Fabry-perot etalon, wavelength measuring apparatus, and wavelength tunable light source device with built-in wavelength measuring apparatus

(75) Inventor: Keisuke Asami, Shinshiro-shi (JP)

Correspondence Address: OLIFF & BERRIDGE, PLC, P.O. BOX 19928, ALEXANDRIA, VA, 22320, US

(73) Assignee: ANDO ELECTRIC CO., LTD., Tokyo (JP)

(21) Appl. No.: 10/011,278

(22) Filed: Dec. 11, 2001

(30) Foreign Application Priority Data
Dec. 27, 2000 (JP) 2000-398584

(51) Int. Cl. G02B 6/26; G02B 6/32; G02B 27/00

(52) U.S. Cl. 385/31; 385/33; 359/577

(57) ABSTRACT

A Fabry-Perot etalon comprises two faces having a reflecting film. A beam is transmitted through the Fabry-Perot etalon and split into two. One face is inclined to the other so that each of the two beams will relatively shift in a phase difference of π/2. The Fabry-Perot etalon is used as a wavelength discrimination unit. The beam transmitted through the Fabry-Perot etalon is branched off by a knife-edged mirror and reflected therein. The branched beams are received by first and second PDs, respectively, and signals which depend on wavelength are detected.

### BACKGROUND OF THE INVENTION

1. Field of the Invention

The present invention relates to a Fabry-Perot etalon (hereinafter, this is also only called an etalon) which is suitable for using for a wavelength discriminating section of a wavelength measuring apparatus for monitoring a wavelength of a laser source of a semiconductor laser or the like used in an optical communication field. The present invention also relates to a wavelength measuring apparatus having the Fabry-Perot etalon in its wavelength discriminating section, and a wavelength tunable light source device in which such a wavelength measuring apparatus is built.

2. Description of Related Art

In the optical communication field, there are wavelength multiplexing communication systems for increasing transmission quantity of information by communicating by multiplexing a beam with a large number of wavelengths in an optical fiber. The wavelength multiplexing communication systems can increase considerably the transmission quantity of information compared with the case using a beam with a single wavelength. Recently, wavelength division multiplexing (WDM) systems in which information is transmitted simultaneously by using a set of laser sources, each generating a coherent beam with a different wavelength (optical communication channels), are known.

In such optical communication systems, a wavelength measuring apparatus is used for distinguishing a wavelength of a laser source. A wavelength measuring apparatus makes a beam emitted from an optical fiber collimated by a lens, and passes the collimated beam through a wavelength discriminating section (whose transmittance or reflectance will change by wavelength) which has wavelength dependency. Then, the wavelength measuring apparatus detects a signal which depends on a wavelength by a photo detector (photo diode; PD).

As wavelength measuring apparatuses, for example, there are a WDM coupler type such as disclosed in the U.S. Pat. No. 5,822,049, Japanese Patent Publication No. Hei 9-297059 or the like, a band pass filter (BPF) type such as disclosed in the Japanese Patent Publication No. Hei 10-253452 or the like, an interferometer type, and an etalon type such as disclosed in the Japanese Patent Publication No. Hei 10-339668 (corresponding to the U.S. Pat. No. 6,043,883).

A WDM coupler type wavelength measuring apparatus is shown in FIG. 7A. An incident beam directed on a WDM coupler 51 from a laser source which is not shown in FIG. 7A is split into optical signals for every different wavelength. The split signal beams are emitted from two optical fibers 52 and 53, respectively. Then, the beams emitted from the optical fibers 52 and 53 are condensed by lenses 54 and 55 and received by PDs 56 and 57, respectively. Finally, signals which depend on wavelength are detected by the PDs 56 and 57, respectively (c.f. wavelength-signal intensity characteristic shown in FIGS. 7B and 7C).

A BPF type wavelength measuring apparatus is shown in FIG. 8A. A beam emitted from an optical fiber 61 becomes a collimated beam by a lens 62. Then, the collimated beam is transmitted through a wavelength discrimination (band pass) filter (BPF) 63 and received by a PD 64. Finally, a signal which depends on wavelength is detected by the PD 64 (c.f. wavelength-signal intensity characteristic shown in FIG. 8B).

An interferometer type wavelength measuring apparatus is shown in FIG. 9A. A beam emitted from an optical fiber 71 becomes a collimated beam by a lens 72. Then, the collimated beam is split into two optical signals, that is, a transmitted beam and a reflected beam, by a beam splitter 73. The transmitted beam is reflected in a reflecting mirror 74 and re-directed on the beam splitter 73. On the other hand, the reflected beam is reflected in a reflecting mirror 75 and re-directed on the beam splitter 73. That is, the split optical signals are multiplexed by the beam splitter 73 so that interference is caused, and received by a PD 76. Finally, a signal which depends on wavelength is detected by the PD 76 (c.f. wavelength-signal intensity characteristic shown in FIG. 9B).

A single etalon type wavelength measuring apparatus is shown in FIG. 10A. A beam emitted from an optical fiber 81 becomes a collimated beam by a lens 82. Then, the collimated beam is directed on an etalon 83 and reflected in multiple within the etalon 83. The beam emitted from the etalon 83 is received by a PD 84. Finally, a signal which depends on wavelength is detected by the PD 84 (c.f. wavelength-signal intensity characteristic shown in FIG. 10B).

A two-etalon type wavelength measuring apparatus is shown in FIG. 11. A beam emitted from an optical fiber 91 becomes a collimated beam by a lens 92. Then, the collimated beam is split into a transmitted beam and a reflected beam. The transmitted beam is reflected in multiple within an etalon 94 and then received by a PD 95. The reflected beam is reflected in multiple within an etalon 96 and then received by a PD 97. Finally, signals which depend on wavelength are detected by the PDs 95 and 97.

Here, the etalons 94 and 96 different in thickness for λ/8, or the etalons 94 and 96 with the same thickness but only one of the two having a slightly inclined optical axis, are used. Thereby, the two optical signals relatively having a phase different of π/2 are emitted from the etalons 94 and 96.

However, the above-described wavelength measuring apparatuses in earlier technology have some problems as the following.

That is, the WDM coupler type or BPF type wavelength measuring apparatus has a defect that the wavelength resolution thereof is low.

Further, in the interferometer or single etalon type wavelength measuring apparatus, although the obtained signal is periodical, it is only one single signal. Therefore, there is a defect that the wavelength measuring apparatus can be used only for wavelength locking, using a slope portion.

In addition, in the two-etalon type wavelength measuring apparatus, although two signals can be obtained, there is a disadvantage that it is physically unstable. Further, there is a defect that it is difficult to be miniaturized.

### SUMMARY OF THE INVENTION

The present invention was made in view of the above-described problems. An object of the present invention is to provide a physically stable Fabry-Perot etalon by single of which two signals can be obtained.

Another object of the present invention is to provide a wavelength measuring apparatus having high resolution, by which direction to which wavelength varies can be recognized in a broad-band.

Further object of the present invention is to provide a wavelength tunable light source device which can monitor and correct oscillation wavelength of a light source.

In order to solve the above-described problems, according to a first aspect of the present invention, a Fabry-Perot etalon for transmitting a beam, having a first face for receiving an incident beam and a second face for emitting an exit beam, each of the first and second faces having a reflecting film, wherein the exit beam includes a first beam and a second beam, and one of the first and the second faces is inclined to the other face so that each of the first and second beams will shift relatively in a phase difference of π/2, the first beam and the second beam are capable of being split in an inclining direction of the one of the first and the second faces. The term “inclining direction” throughout the specification is the direction where the inclination of the Fabry-Perot etalon is proceeding. In other words, it is the direction where the thickness of the Fabry-Perot etalon is varying. Preferably, the inclined face may be the second face.

According to the Fabry-Perot etalon of the present invention, since one face is inclined to the other face, each of the beams that the beam transmitted through the Fabry-Perot etalon is split into two shifts relatively in a phase difference of π/2, as expected. Thus, two signals can be obtained by a single Fabry-Perot etalon. Further, since a single Fabry-Perot etalon is used, it is physically stable.

According to a second aspect of the present invention, a wavelength measuring apparatus comprising: an optical fiber; a lens for making a beam emitted from the optical fiber a collimated beam; a Fabry-Perot etalon as a wavelength discrimination unit which has a wavelength dependency and transmits the collimated beam, the Fabry-Perot etalon having a first face for receiving the collimated beam and a second face for emitting the collimated beam, each face having a reflecting film, the collimated beam transmitted through the Fabry-Perot etalon including a first beam and a second beam, one of the first and the second faces being inclined to the other face so that each of the first and second beams will shift relatively in a phase difference of π/2; a knife-edge mirror for branching the first and the beams off in an inclining direction of the one of the first and the second faces and for reflecting the branched beams; a first photo detector for receiving one of the branched beams; and a second photo detector for receiving the other branched beam. Here, the inclining direction of the Fabry-Perot etalon relates to the arrangement of the knife-edge mirror. Preferably, the inclined face may be the second face. Further, a polarization maintaining fiber may be used as the optical fiber. Moreover, the wavelength measuring apparatus may comprise: a beam splitter for reflecting a portion of the collimated beam toward a side; and a third photo detector for receiving the beam reflected from the beam splitter. The beam splitter and the third photo detector may be provided between the lens and the Fabry-Perot etalon. Furthermore, the wavelength measuring apparatus may further comprise an optical isolator for preventing a return of a reflected beam. The optical isolator may be provided between the lens and the Fabry-Perot etalon.

According to the wavelength measuring apparatus of the present invention, a Fabry-Perot etalon having one face inclined to the other face is used as a wavelength discrimination unit, and the beam transmitted through the Fabry-Perot etalon is branched off by a knife-edge mirror. Then, the branched beams are reflected by the knife-edge mirror, and the reflected beams are received by first and second photo detectors, respectively. The Fabry-Perot etalon has an inclined face so that the beams branched and reflected by the knife-edge mirror may be shifted relatively in a phase difference of π/2. This phase difference is caused according to different optical path length (optical length) of the branched beams in the Fabry-Perot etalon. As a result, two signals which depend on wavelength may be obtained. Therefore, two physically stable signals can be obtained, so that the wavelength measuring apparatus can have high resolution, and a direction to which wavelength varies can be recognized in a broad-band. Further, since only a single Fabry-Perot etalon is used, it can be miniaturized in comparison with the two-etalon type wavelength measuring apparatus in earlier technology. A PMF may be used as the optical fiber. Therefore, a detection error by polarization dependency can be suppressed. Moreover, since a beam splitter and a third photo detector may be provided between the lens and the Fabry-Perotn etalon, and the beam reflected in the beam splitter may be received by the third photo detector, a wavelength detecting error by power fluctuation can be suppressed. Furthermore, since an optical isolator may be provided between the lens and the Fabry-Perot etalon, return of a reflected beam can be prevented.

According to a third aspect of the present invention, a wavelength tunable light source device comprises: a wavelength measuring apparatus which comprises: an optical fiber; a lens for making a beam emitted from the optical fiber a collimated beam; a Fabry-Perot etalon as a wavelength discrimination unit which has a wavelength dependency and transmits the collimated beam, the Fabry-Perot etalon having a first face for receiving the collimated beam and a second face for emitting the collimated beam, each face having a reflecting film, the collimated beam transmitted through the Fabry-Perot etalon including a first beam and a second beam, one of the first and the second faces being inclined to the other face so that each of the first and second beams will shift relatively in a phase difference of π/2; a knife-edge mirror for branching the first and the beams off in an inclining direction of the one of the first and the second faces and for reflecting the branched beams; a first photo detector for receiving one of the branched beams; and a second photo detector for receiving the other branched beam. An oscillation wavelength of a light source is monitored and corrected on the basis of wavelength information obtained by the wavelength measuring apparatus. The wavelength tunable light source device may further comprise a correcting unit for correcting the oscillation wavelength of the light source. The wavelength tunable light source device may furthermore comprise a monitoring unit for monitoring the oscillation wavelength of the light source.

According to the wavelength tunable light source device, a wavelength measuring unit comprising a Fabry-Perot etalon having one face inclined to the other face so that signals relatively having a phase difference of π/2 may be obtained is built in the wavelength tunable light source device. Therefore, an oscillation wavelength of a light source can be monitored and corrected on the basis of the wavelength information obtained by the wavelength measuring unit.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein;

FIG. 1 is a schematic view showing a wavelength measuring apparatus according to a first embodiment of the present invention;

FIG. 2 is a schematic view showing a wavelength measuring apparatus according to a second embodiment of the present invention;

FIG. 3 is a schematic view showing a wavelength measuring apparatus according to a third embodiment of the present invention;

FIG. 4A is an enlarged view showing a Fabry-Perot etalon with an inclined face, a knife-edge mirror, and a first PD and a second PD in FIGS. 1 to 3;

FIG. 4B is a view showing a wavelength-signal intensity characteristic detected by the first PD;

FIG. 4C is a view showing wavelength-signal intensity characteristics detected by the first and second PDs;

FIG. 5 is a block diagram showing a wavelength tunable light source device according to a fourth embodiment of the present invention;

FIG. 6 is a block diagram showing a wavelength tunable light source device according to a fifth embodiment of the present invention;

FIG. 7A a schematic view showing a WDM type wavelength coupler in earlier technology;

FIG. 7B a view showing a wavelength-signal intensity characteristic detected by a PD in FIG. 7A;

FIG. 7C a view showing a wavelength-signal intensity characteristic detected by the other PD in FIG. 7A;

FIG. 8A is a schematic view showing a BFP type wavelength measuring apparatus in earlier technology;

FIG. 8B is a view showing a wavelength-signal intensity characteristic detected by a PD in FIG. 8A;

FIG. 9A is a schematic view showing an interferometer type wavelength measuring apparatus in earlier technology;

FIG. 9B is a view showing a wavelength-signal intensity characteristic detected by a PD in FIG. 9A;

FIG. 10A is a schematic view showing a single etalon type wavelength measuring apparatus in earlier technology;

FIG. 10B is a view showing a wavelength-signal intensity characteristic detected by a PD in FIG. 10A;

FIG. 11 is a schematic view showing a two-etalon type wavelength measuring apparatus in earlier technology.

### PREFERRED EMBODIMENT OF THE INVENTION

Hereinafter, the embodiments according to the present invention will be explained with reference to the figures.

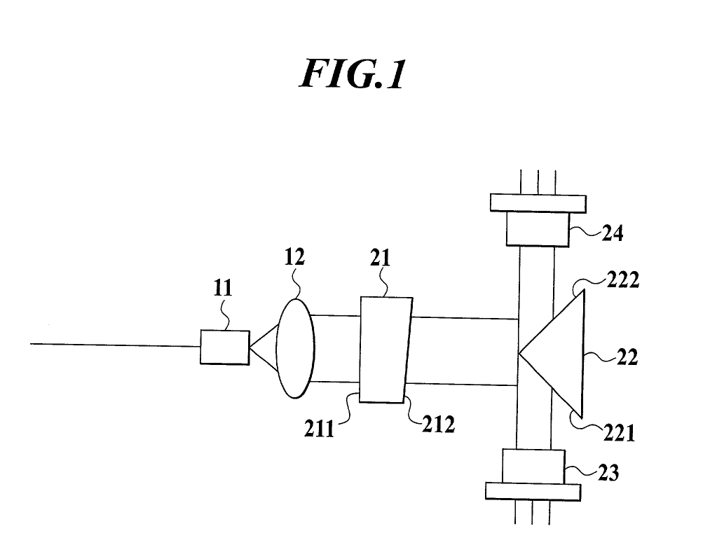

In a first embodiment according to the present invention, as shown in FIG. 1, a wavelength measuring apparatus comprises an optical fiber 11, a lens 12, a Fabry-Perot etalon with an inclined face (hereinafter, called the etalon of the present invention) 21, a knife-edge mirror 22, a first PD (first photo detector) 23, and a second PD (second photo detector) 24.

A beam from a laser source which is not shown in FIG. 1 is emitted from the optical fiber 11. As the optical fiber 11, a polarization maintaining fiber (PMF) is desirable in order to suppress a detection error by polarization dependency.

The lens 12 is for making the beam emitted from the optical fiber 11 a collimated beam.

The etalon of the present invention 21 has reflecting films in both surfaces of glass or prism. The etalon of the present invention 21 is for emitting a beam directed thereon after reflecting the incident beam in multiple in the inside thereof. The beam emitted from the etalon of the present invention 21 is split into two by the knife-edge mirror 22, as described later. Incidentally, as shown in FIG. 1, the etalon of the present invention 21 is formed by inclining an optical exit face (inclined face) 212 to an optical incident face 211 so that the mutual optical path length (optical length) of the split beams in the etalon of the present invention 21 may differ for λ/8 on the average.

The knife-edge mirror 22 has reflecting surfaces 221 and 222 for reflecting the beam transmitted through the etalon of the present invention 21 by bisecting the transmitted beam in the direction of the exit face (inclined face) of the etalon of the present invention 21, as shown in FIG. 1. In addition, the knife-edge mirror 22 may be the one that can not only bisect but also split the beam into two.

The first PD 23 receives the beam reflected by the reflecting surface 221 of the knife-edge mirror 22, and detects a signal which depends on wavelength.

The second PD 24 receives the beam reflected by the reflecting surface 222 of the knife-edge mirror 22, and detects a signal which depends on wavelength.

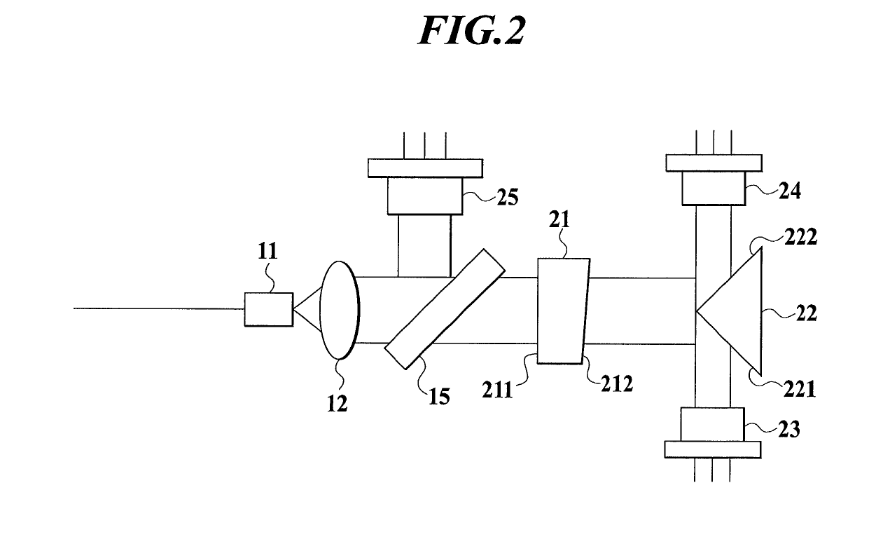

In a second embodiment according to the present invention, as shown in FIG. 2, a wavelength measuring apparatus comprises a beam splitter 15 and a third photo detector (third PD) 25 besides the above-described construction of the first embodiment.

That is, the beam splitter 15 for reflecting a portion of a collimated beam passed through the lens 12 toward a side is provided in the optical path between the lens 12 and the etalon of the present invention 21. Then, the reflected beam from the beam splitter 15 is received by the third PD 25, so that power fluctuation may be detected.

In addition, the beam splitter 15 with reflectance of about 5 to 50 % is desirable.

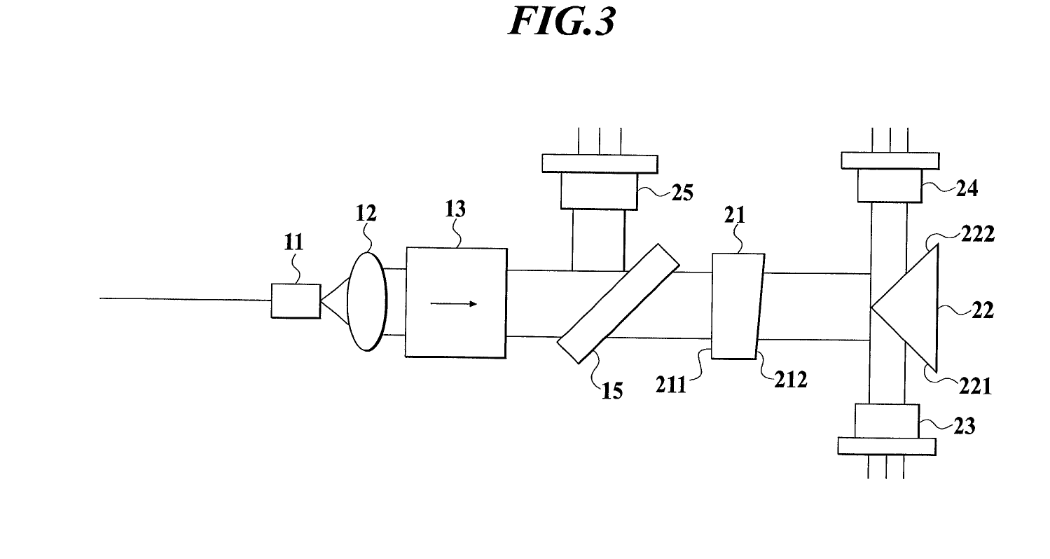

In a third embodiment according to the present invention, as shown in FIG. 3, a wavelength measuring apparatus further comprises an optical isolator 13 in the optical path between the lens 12 and beam splitter 15 besides the above-described construction of the second embodiment. The optical isolator 13 prevents the return of the reflected beam.

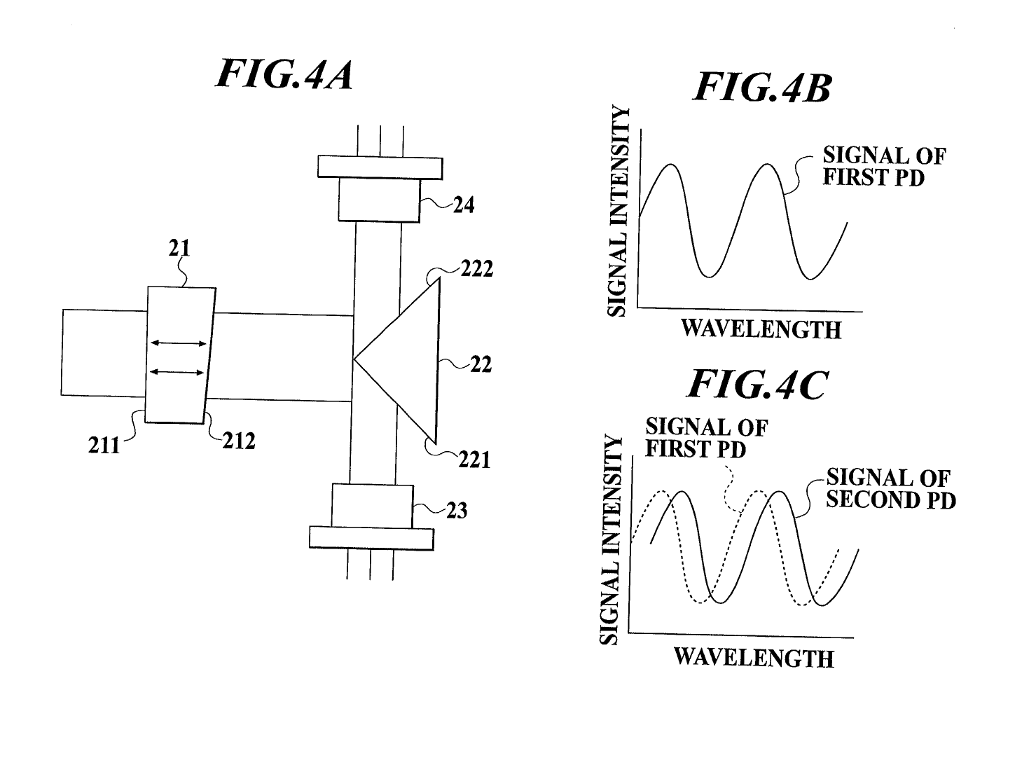

Next, the etalon of the present invention 21 will be explained in detail as the following. FIG. 4A is an enlarged view showing the etalon of the present invention 21, the knife-edge mirror 22, the first PD 23, and the second PD 24 that are used in the above-described wavelength measuring apparatuses. As described later, the beam emitted from the etalon of the present invention 21 is split into two (or bisected) by the knife-edge mirror 22.

As shown in FIG. 4A, the exit face 212 of the etalon of the present invention 21 is inclined compared with the incident face 211 thereof so that the mutual optical path (optical length) of the split beams in the etalon of the present invention 21 may differ for λ/8 on the average. Here, the fine adjustment of the incline is carried out by adjusting the size of beam radius, for example, by condensing or diffusing slightly the beam or the like.

In addition, in the etalon of the present invention 21, if the plate thickness is too thin, wavelength resolution will become low, and if too thick, error will be caused when mode-hopping occurs. Therefore, it is desirable to set the free spectral range (FSR) as about 0.1 nm to 0.5 nm. The concrete plate thickness is, for example, about 1.5 mm to 8 mm (however, when a refractive index is set to 1.5).

The collimated beam directed on the etalon of the present invention 21 is reflected in multiple within the etalon of the present invention 21. Then, the beam emitted from the etalon of the present invention 21 is bisected by the reflecting surfaces 221 and 222 of the knife-edge mirror 22, and the bisected beams are reflected in the knife-edge mirror 22. The reflected beams are received by the first PD 23 and the second PD 24, respectively. In addition, the knife-edge mirror 22 may be the one that can not only bisect but also split the beam into two.

After the beam which is reflected in the reflecting surface 221 of the knife-edge mirror 22 is received by the first PD 23, a signal which has a periodical amplitude is detected as the wavelength-signal intensity characteristic shown in FIG. 4B. Here, the signal is desirable to be brought close to a sinusoidal signal. Further, it is desirable to optimize reflectance of reflecting films on both faces (the incident face 211 and the exit face (inclined face) 212) of the etalon of the present invention 21 beforehand.

After the beam which is reflected in the reflecting surface 222 of the knife-edge mirror 22 is received by the second PD 24, as the wavelength-signal intensity characteristic shown in FIG. 4C, a signal similar to a sine wave (c.f. characteristic of a solid line) is detected. That is, the signal detected by the second PD 24 is π/2 phase shifted to the signal detected by the first PD 23 (c.f. characteristic of a dotted line).

Incidentally, a periodical amplitude can realize high wavelength resolution. However, if it is only a single signal, resolution of peaks and valleys of sinusoidal characteristic is low, so that the direction to which wavelength varies cannot be recognized in a broadband.

On the other hand, if π/2-phase-shifted two signals are used, for example, the same as the principle of an encoder which is used for a servomotor, each signal mutually covers the peaks and valleys of inusoidal wavelength of the mutual signal. Therefore, stable resolution and recognition of direction to which wavelength varies become possible.

Therefore, according to the wavelength measuring apparatus of each embodiment, in which the etalon of the present invention 21 is used, it has high resolution. Further, direction to which wavelength varies can be recognized in a broad-band.

Further, since only a single Fabry-Perot etalon with an inclined face 21 is used, the construction can be simple compared with the two-etalon type wavelength measuring apparatus in earlier technology.

Moreover, since two signals can be obtained by a single Fabry-Perot etalon with an inclined face 21, it is physically stable and can be miniaturized.

In a fourth embodiment according to the present invention, as shown in FIG. 5, a wavelength tunable light source device 30 comprises a light source unit 31, a motor 32, a driver/controller for motor 33, a CPU 34, a beam splitter 35, a wavelength measuring apparatus 36 in which the etalon of the present invention 21 is used, and an operating (calculation) circuit 37. The light source unit 31 and the motor 32 form a wavelength tunable light source (light source).

At first, in the CPU 34, data for emitting a beam with desired wavelength is set, and its data signal is outputted from the CPU 34 to the driver/controller for motor 33. The driver/controller for motor 33 further outputs the data signal to the motor 32. Then, the motor 32 actuates the light source unit 31 on the basis of the signal inputted from the driver/controller for motor 33. Thereby, a beam with desired wavelength is emitted from the light source unit 31.

A portion of the beam emitted from the light source unit 31 is reflected in the beam splitter 35, and directed on the wavelength measuring apparatus 36 in which the etalon of the present invention 21 is used. Thereby, wavelength information of two signals relatively having a phase difference of π/2 is obtained by the wavelength measuring apparatus 36. The obtained wavelength information is inputted in the operating circuit 37.

The CPU 34 monitors the operating circuit 37, and outputs a signal of correcting wavelength to the driver/controller for motor 33 on the basis of the operation result in the operating circuit 37. That is, for example, when an error is caused in the wavelength information obtained by the wavelength measuring apparatus 36, the CPU 34 first recognizes the error by monitoring the operating circuit 37, and then outputs a signal to the driver/controller for motor 33 so that the error will be corrected by the motor 32 actuating the light source unit 31.

Then, the driver/controller for motor 33 outputs a signal for correcting the error to the motor 32 according to the signal from the CPU 34. Thereby, the light source unit 31 is actuated, so that the wavelength is corrected and a beam with desired wavelength is emitted again.

Thus, in the wavelength tunable light source device 30, the oscillation wavelength of the wavelength tunable light source can be corrected by making the CPU 34 monitor the wavelength information obtained by the wavelength measuring apparatus 36 in which the etalon of the present invention 21 is used.

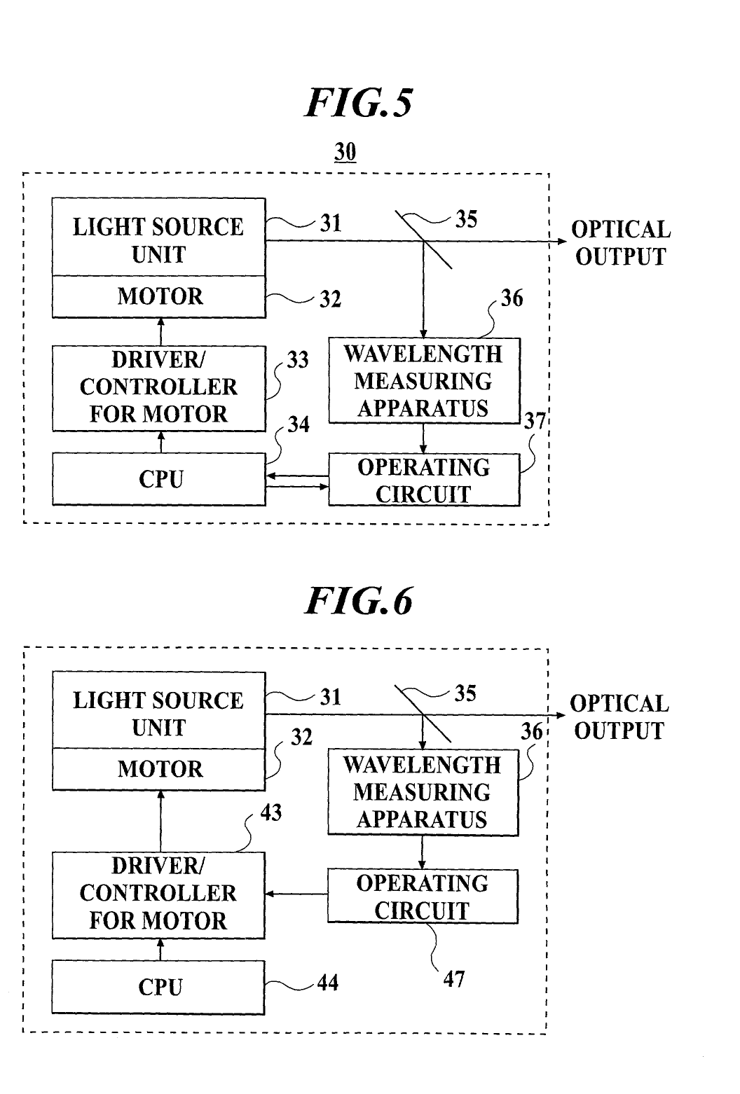

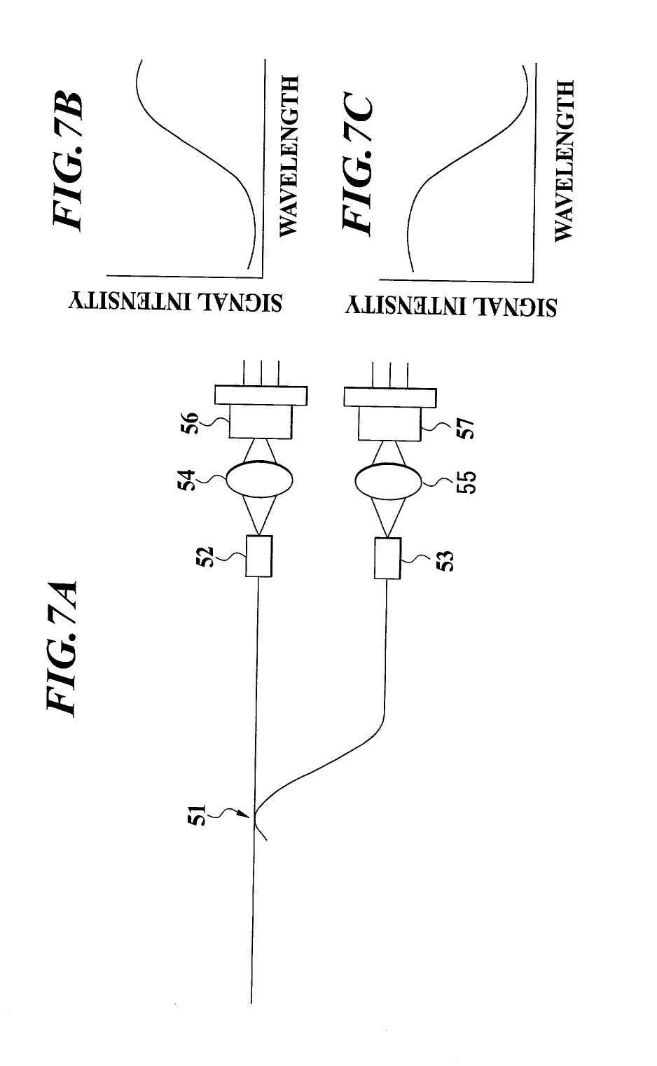

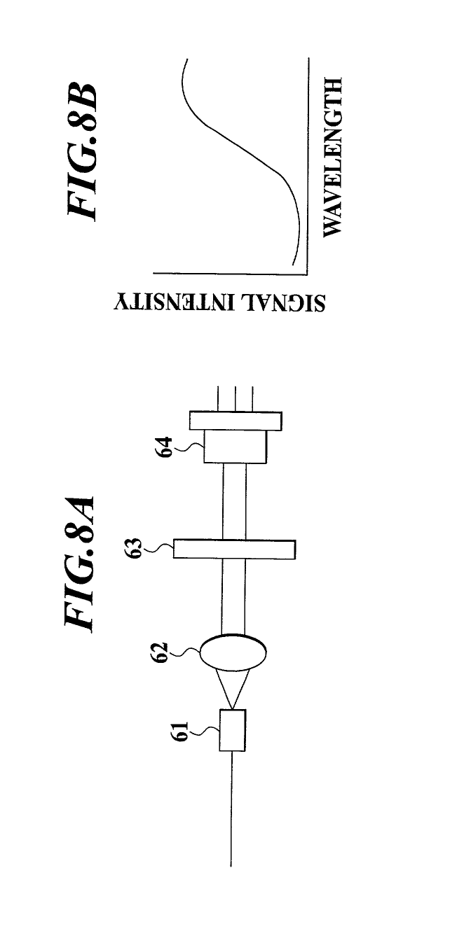

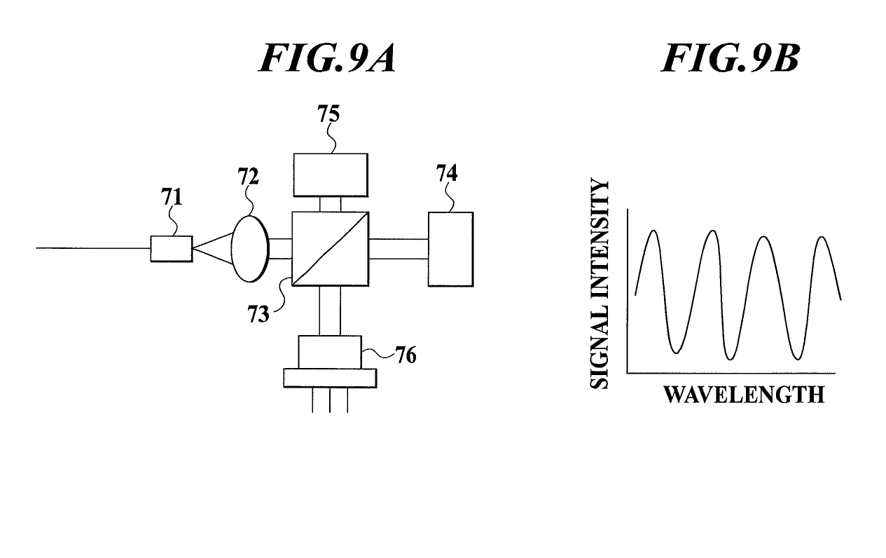

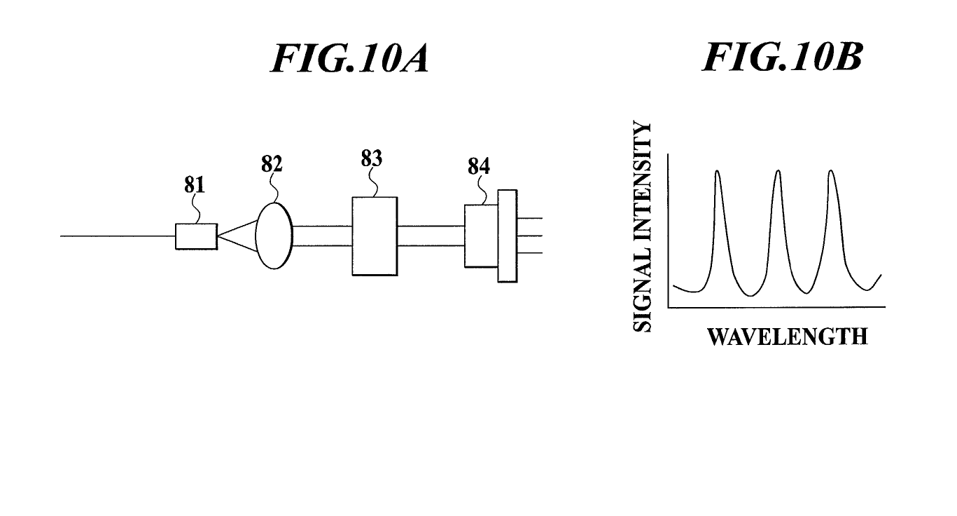

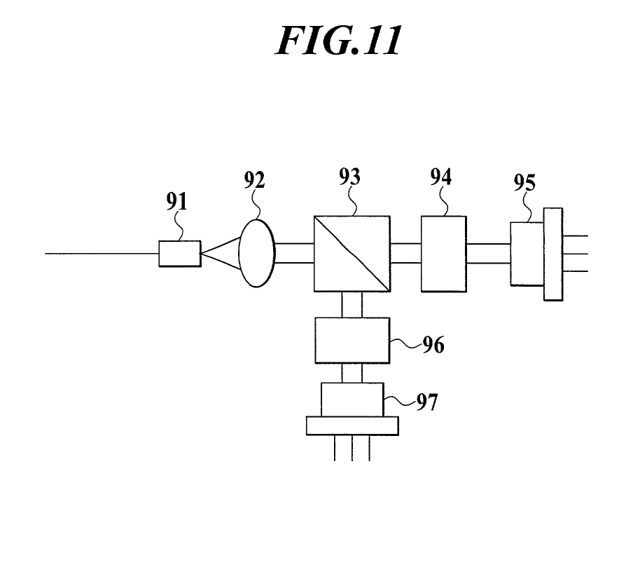

In a fifth embodiment according to the present invention, as shown in FIG. 6, a wavelength tunable light source device 40 comprises a light source unit 31, a motor 32, a driver/controller for motor 43, a CPU 44, a beam splitter 35, a wavelength measuring apparatus 36 in which the etalon of the present invention 21 is used, and an operating circuit 47. Here, since the light source unit 31, the motor 32, the beam splitter 35, and the wavelength measuring apparatus 36 are the same as those shown in FIG. 5, detail explanation is omitted.

At first, as the same as the above-described wavelength tunable light source device 30, data for emitting a beam with desired wavelength is set in the CPU 44. Thereby, a beam with desired wavelength is emitted from the light source unit 31.

A portion of the beam emitted from the light source unit 31 is reflected in the beam splitter 35 and directed on the wavelength measuring apparatus 36, so that wavelength information of two signals relatively having a phase difference of π/2 is obtained by the wavelength measuring apparatus 36. The obtained wavelength information is inputted in the operating circuit 47.

Here, in the operating circuit 47, a predetermined operating program is stored. This is for detecting an error of the wavelength information obtained by the wavelength measuring apparatus 36. When the operation result is less/more than a predetermined value, the operating circuit 47 recognizes that an error is caused in the wavelength information obtained by the wavelength measuring apparatus 36. Then, the operating circuit 47 outputs a signal for correcting the error to the driver/controller for motor 43.

The driver/controller for motor 43 outputs a signal to the motor 32 according to the signal from the operating circuit 47. Thereby, the wavelength is corrected.

Thus, in the wavelength tunable light source device 40, oscillation wavelength of the wavelength tunable light source can be corrected on the basis of the wavelength information obtained by the wavelength measuring apparatus 36 in which using the etalon of the present invention 21 is used.

Thus, any of the wavelength measuring apparatus of the above-described first to third embodiments, in which the etalon of the present invention 21 is used, is built in a wavelength tunable light source device. Thereby, oscillation wavelength of a light source can be monitored and corrected on the basis of the wavelength information obtained by the built-in wavelength measuring apparatus.

In the above, the embodiments of the present invention are explained. However, it is needless to say that the present invention is not limited to such embodiments, but various modifications are possible in a range within the scope of the present invention.

The entire disclosure of Japanese Patent Application No. 2000-398584 filed on Dec. 27, 2000 including specification, claims, drawings and summary are incorporated herein by reference in its entirety.

What is claimed is:

1. A Fabry-Perot etalon for transmitting a beam, having a first face for receiving an incident beam and a second face for emitting an exit beam, each of the first and second faces having a reflecting film,
wherein the exit beam includes a first beam and a second beam, and one of the first and the second faces is inclined to the other face so that each of the first and second beams will shift relatively in a phase difference of π/2, the first beam and the second beam are capable of being split in an inclining direction of the one of the first and the second faces.

2. A wavelength measuring apparatus comprising:
an optical fiber;
a lens for making a beam emitted from the optical fiber a collimated beam;
a Fabry-Perot etalon as a wavelength discrimination unit which has a wavelength dependency and transmits the collimated beam, the Fabry-Perot etalon having a first face for receiving the collimated beam and a second face for emitting the collimated beam, each face having a reflecting film, the collimated beam transmitted through the Fabry-Perot etalon including a first beam and a second beam, one of the first and the second faces being inclined to the other face so that each of the first and second beams will shift relatively in a phase difference of π/2;
a knife-edge mirror for branching the first and the beams off in an inclining direction of the one of the first and the second faces and for reflecting the branched beams;
a first photo detector for receiving one of the branched beams; and
a second photo detector for receiving the other branched beam.

3. The wavelength measuring apparatus as claimed in claim 2, wherein a polarization maintaining fiber is used as the optical fiber.

4. The wavelength measuring apparatus as claimed in claim 2, comprising:
a beam splitter for reflecting a portion of the collimated beam toward a side; and
a third photo detector for receiving the beam reflected from the beam splitter;
wherein the beam splitter and the third photo detector are provided between the lens and the Fabry-Perot etalon.

5. The wavelength measuring apparatus as claimed in claim 2, further comprising:
an optical isolator for preventing return of a reflected beam, the optical isolator being provided between the lens and the Fabry-Perot etalon.

6. A wavelength tunable light source device comprising:
a wavelength measuring apparatus which comprises: an optical fiber; a lens for making a beam emitted from the optical fiber a collimated beam; a Fabry-Perot etalon as a wavelength discrimination unit which has a wavelength dependency and transmits the collimated beam, the Fabry-Perot etalon having a first face for receiving the collimated beam and a second face for emitting the collimated beam, each face having a reflecting film, the collimated beam transmitted through the Fabry-Perot etalon including a first beam and a second beam, one of the first and the second faces being inclined to the other face so that each of the first and second beams will shift relatively in a phase difference of π/2; a knife-edge mirror for branching the first and the beams off in an inclining direction of the one of the first and the second faces and for reflecting the branched beams; a first photo detector for receiving one of the branched beams; and a second photo detector for receiving the other branched beam;
wherein an oscillation wavelength of a light source is monitored and corrected on the basis of wavelength information obtained by the wavelength measuring apparatus.

7. The wavelength tunable light source device as claimed in claim 6, further comprising: a correcting unit for correcting the oscillation wavelength of the light source.

8. The wavelength tunable light source device as claimed in claim 6, furthermore comprising: a monitoring unit for monitoring the oscillation wavelength of the light source.
